(19) United States
(12) Patent Application Publication
(10) Pub. No.: US 2016/0200131 A1
(43) Pub. Date: Jul. 14, 2016

(54) BINDING ELEMENT FOR BINDING LEAVES IN A BINDING FOLDER WITH A COVER AND METHOD APPLIED THEREWITH

(71) Applicant: UNIBIND LIMITED, Nicosia (CY)

(72) Inventor: Guido PELEMAN, Antwerpen (BE)

(21) Appl. No.: 15/023,447

(22) PCT Filed: Nov. 21, 2014
(86) PCT No.: PCT/IB2014/002538

§ 371 Date: Mar. 21, 2016

(30) Foreign Application Priority Data
Nov. 26, 2013 (BE) 2013/0797

(51) Int. Cl. B42D 1/00; B42C 7/00

(52) U.S. Cl. CPC B42D 1/002; B42C 7/00

(57) ABSTRACT

Binding element that includes a metal spine (2) and a binding adhesive (12) in the form of a hotmelt adhesive, whereby a cover strip (7) of paper, plastic, metal foil or similar is provided on the inside (6) of the spine (2), that on the side oriented towards the inside (6) of the spine (2) is provided with an assembly adhesive (8) in the form of a hotmelt adhesive with a melting temperature that is higher than that of the binding adhesive (12), and with which the cover strip (7) is bonded to the inside (6) of the metal spine (2) to form a free lip (9) on each arm (4), whereby the lips (9) protrude from the metal spine (2) past the arms (4) towards the outside.

The present invention relates to a binding element for binding leaves in a binding folder with a cover.

It is already known to bind leaves in a thermal binding folder of cardboard, whereby a hotmelt adhesive is placed in the spine of the binding folder that is made to melt by heating the spine during binding so that the leaves can be pushed into the molten adhesive, and after the adhesive has cooled and solidified these leaves are bonded in the binding folder.

A disadvantage of such thermal binding folders is that the opening of the spine may only be a little wider than the thickness of the [bundle] to be bound because otherwise a thick unsightly gap would remain open between the bundle and the arms of the spine, which is unacceptable for a binding folder that must radiate prestige.

This means that if this disadvantage is to be avoided and bundles of variable thicknesses are to be bound, a multitude of spine widths for binding folders must be kept in stock, that generally increase by 2 millimetres.

As is also known, use is made of a U-shaped metal spine with hotmelt adhesive on the inside of the spine, whereby this spine is affixed in the binding folder beforehand.

However, a disadvantage of such a metal spine is that the leaves on the outside of the bundle to be bound, when introducing the bundle in the binding folder, cling to the free edges of the arms of the metal spine, such that the outermost leaves protrude somewhat more out of the bundle along their edges than the leaves more towards the middle, which again spoils the appearance of the binding folder with bound leaves.

Another disadvantage of such a metal spine is the risk of injuries from the sharp edges and corners of the metal.

For the production of such a binding folder of cardboard with a metal spine, a flat spine is sometimes taken that is bonded in the middle of a flat cardboard sheet, after which the spine together with the cardboard bonded to it is folded into a U, which however can give rise to local tearing of the cardboard at the location of the fold, as cardboard is not elastic and the cardboard on the outside of the spine must be able to be longer due to the fold around the spine.

The purpose of the present invention is to provide a solution to one or more of the aforementioned and other disadvantages.

To this end the invention concerns a binding element for binding leaves in a binding folder with a cover, whereby this binding element essentially comprises a metal spine and a binding adhesive in the form of a hotmelt adhesive, whereby the metal spine is essentially formed as a U-shaped profile with a base and upright arms, characterised in that the inside of the metal spine, at least at the location of the arms, is provided with at least one cover strip of paper, plastic, metal foil or similar, that on the side oriented towards the spine is provided with an assembly adhesive in the form of a hotmelt adhesive with a melting temperature that is higher than that of the binding adhesive, and with which the cover strip is bonded to a section on the inside of the metal spine to form a free lip on each arm, whereby the lips protrude from the metal spine past the arms towards the outside, and are provided with assembly adhesive on their outside.

An advantage of such a binding element is that it is a semi-finished product that enables a binding folder to be produced with a professional appearance in a similar way.

It is sufficient to affix a sheet of cardboard or similar over the binding element and to fold it over the outside of the metal spine up to contact with the lips, and then to heat the lips to make the assembly adhesive on the lips to melt and then to allow the adhesive to cool in order to bring about the bond between the cover and the binding element.

In this way the cover can be folded around the metal spine without stresses which prevents the cover breaking at the location of the folds.

Moreover, in this way the free longitudinal edges of the arms of the metal spine are covered by the cover strips, which prevents the outermost leaves from clinging behind these metal edges when introducing a bundle of leaves to be bound in the binding folder.

In addition the risk of injury on the metal spine is ruled out.

Preferably the metal spine is constructed such that the arms of the spine can be folded towards one another.

This provides the advantage that a number of thicknesses of bundles of leaves can be bound with the same size of spine, as when using thinner bundles the difference between the thickness of the bundle and the width of the metal spine can be easily accommodated by pressing the arms towards one another up to against the outermost leaves of the bundle so that no open gap can be seen by the user.

In this way one single spine width of a binding element according to the invention can replace five spine widths of a conventional thermal binding folder, for example, such that less stock has to be held.

The invention also relates to a binding folder with cover, whereby the binding folder comprises a cover of cardboard or similar and a binding element according to the invention to form the spine of the binding folder, and whereby the cover runs over the outside of the metal spine of the binding element and is fastened to the binding element at least by means of an assembly adhesive on the free lips of the binding element.

The invention also relates to a method for forming such a binding folder, which starts with a binding element according to the invention and a sheet of cardboard or similar to form the cover, whereby the cover is folded over and against the outer surface of the binding element up to against the lips of the binding element with assembly adhesive, after which the assembly adhesive on these lips is heated to locally melt the assembly adhesive and then to allow the assembly adhesive to cool to bring about the bond between the binding element and the cover.

A practical method consists of affixing the metal spine in the reverse position, i.e. with the arms downwards, over a slat that is heated at the location of the lips to a temperature that is greater than or equal to the melting temperature of the assembly adhesive, after which the cardboard sheet that is to form the cover is laid on the binding element and is folded downwards around the outer surface of the metal spine of the binding element up to against the molten assembly adhesive.

With the intention of better showing the characteristics of the invention, a few preferred embodiments of a binding element according to the invention for binding leaves in a binding folder with a cover and a method applied therewith are described hereinafter by way of an example, without any limiting nature, with reference to the accompanying drawings, wherein:

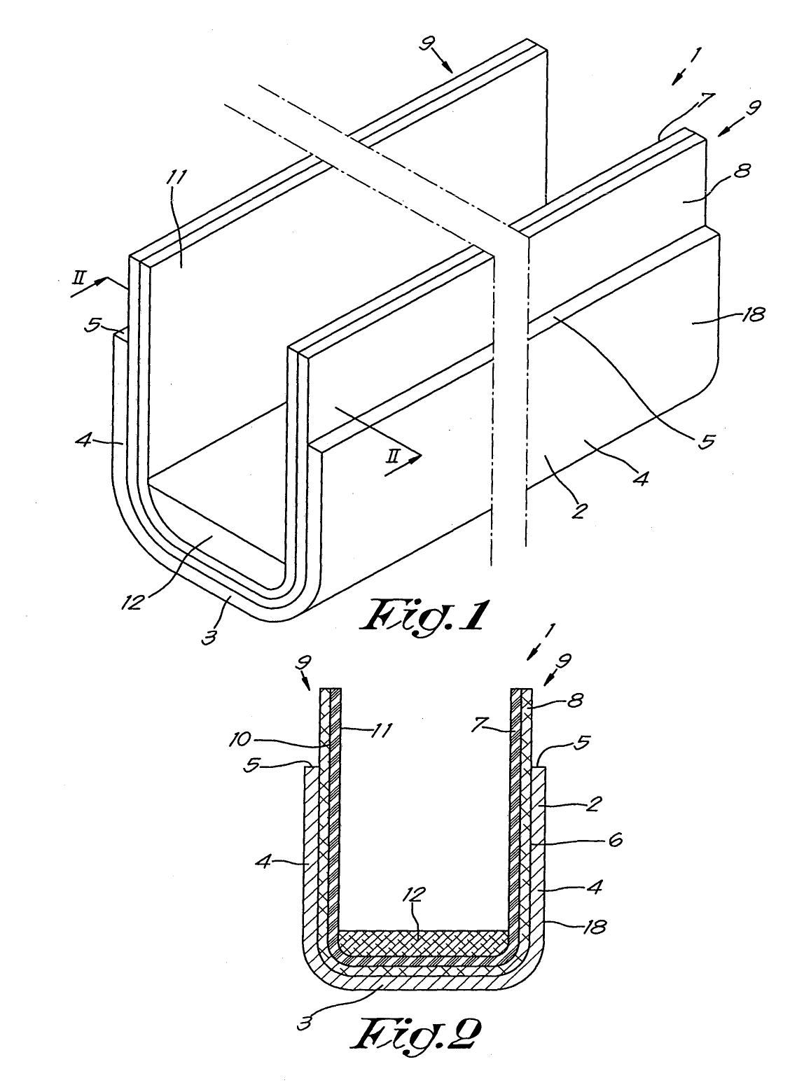

FIG. 1 schematically shows a perspective view of a binding element according to the invention;

FIG. 2 shows a cross-section according to line II-II in FIG. 1;

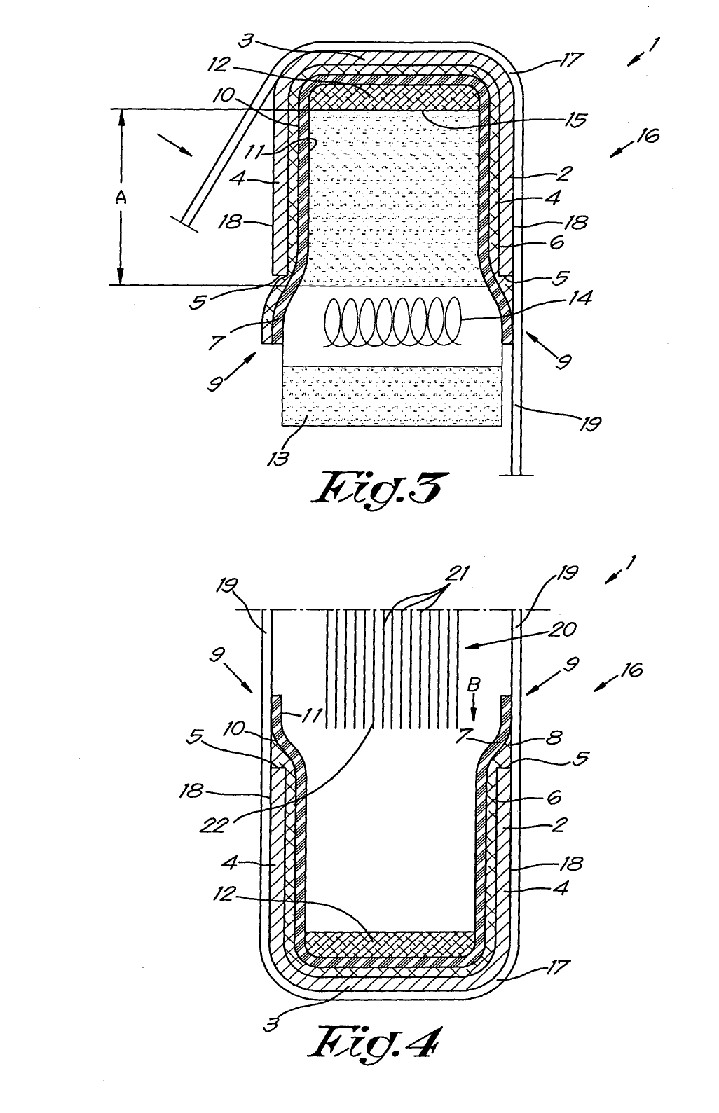

FIG. 3 illustrates the use of the binding element of FIG. 1 for the production of a binding folder with cover;

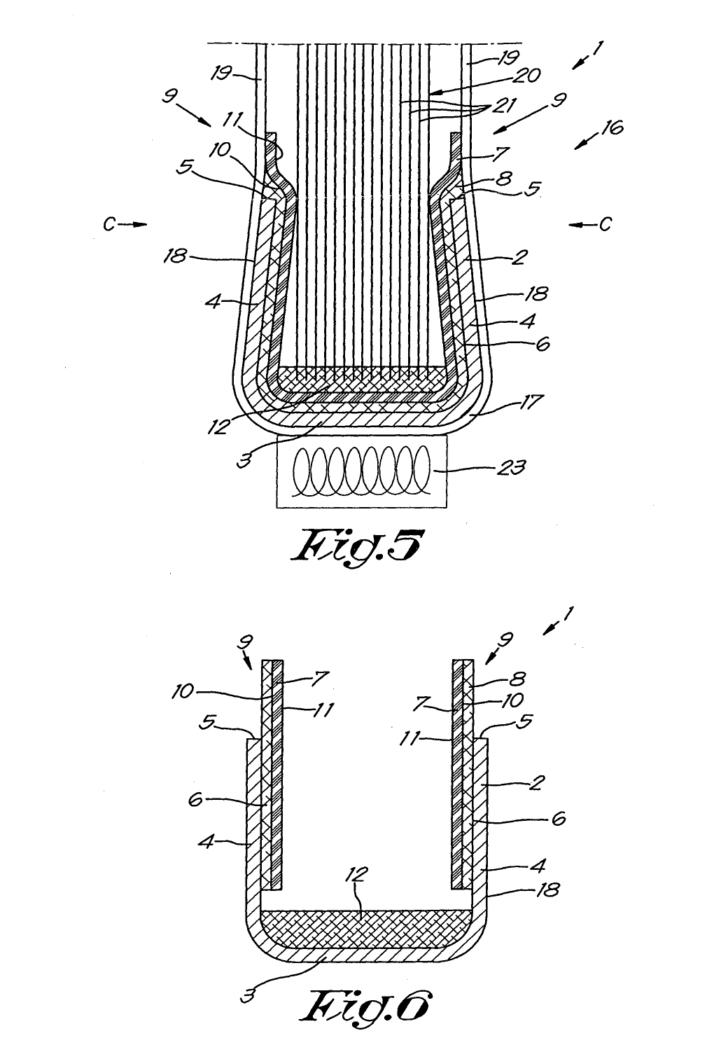

FIGS. 4 and 5 illustrate the use of the binding folder of FIG. 3 for binding a bundle of leaves;

FIG. 6 shows a variant embodiment of the binding element of FIG. 1;

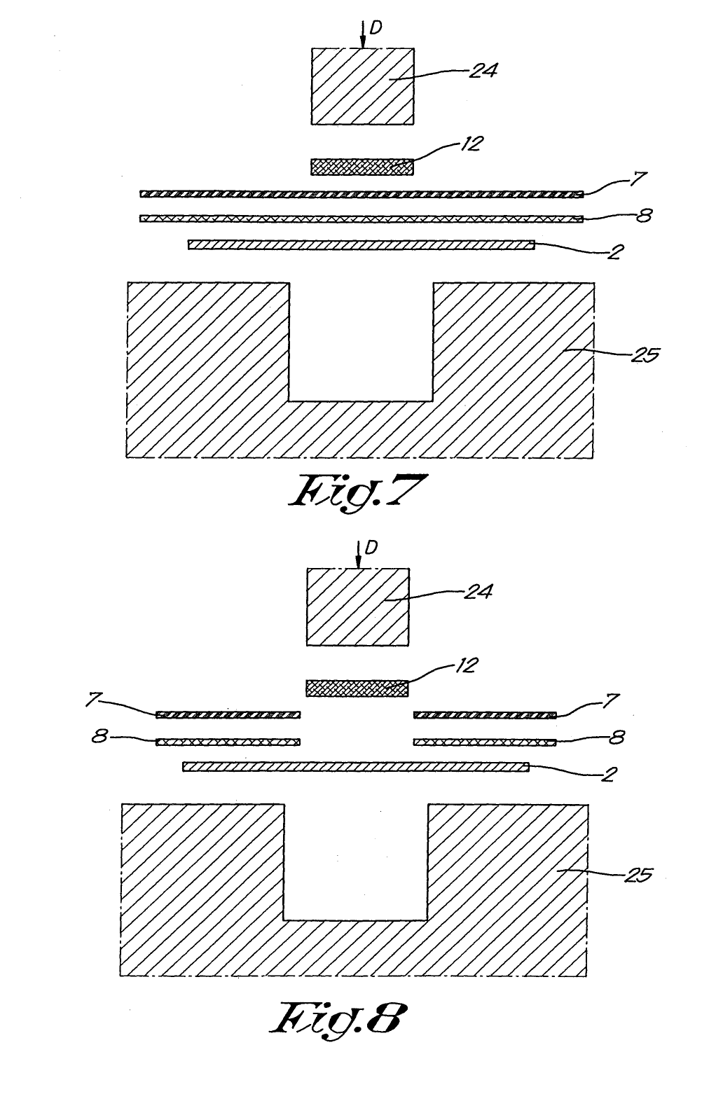

FIG. 7 illustrates a method for producing the binding element of FIG. 1;

FIG. 8 illustrates a method for producing the binding element of FIG. 6.

The binding element 1 according to the invention shown in FIGS. 1 and 2 comprises a metal spine 2 that is essentially formed as a U-shaped profile with a base 3 and two upright arms 4.

The metal spine 2 is constructed such that the free longitudinal edges 5 of the arms 4 can be folded towards one another.

A cover strip 7 of paper, plastic or metal foil or similar is provided on the inside 6 of the metal spine 2 that is provided on the side oriented towards the spine 2 with a layer of assembly adhesive 8 in the form of a hotmelt adhesive with a melting temperature that is between 120° C. and 140° C. for example, preferably with a melting temperature of around 130° C.

The cover strip 7 is bonded to the inside 6 of the metal spine 2 by means of the assembly adhesive 8, in other words to the side 6 that is oriented towards the middle of the spine 2 and this in such a way that a free lip 9 of paper, plastic or similar is formed on each arm 4, that protrudes from the metal spine 2 past the free edge 9 of the arm 4 concerned.

These lips 9 of paper, plastic or similar are provided on their outside 10 with assembly adhesive 8.

In this case the lips 9 are formed by a cover strip 7 that runs over the base 3 of the metal spine 2 from one arm 4 to the other arm 4, whereby this cover strip 7 extends over the entire or practically entire inside 6 of the metal spine 2.

A layer of binding adhesive 12 is applied over the width of the base 3 on the inside 11 of the cover strip 7 at the location of the base 3 of the metal spine 2, whereby the binding adhesive 12 is a hotmelt adhesive that is chosen such that the its melting temperature is less than the melting temperature of the assembly adhesive 8 and for example has a melting temperature of around 80° C. to 90° C.

The thicknesses of the metal spine 2, the cover strip 7 and the layer of assembly adhesive 8 are not drawn to scale, and this for the clarity of the drawings. In reality the thickness of the assembly adhesive 8 is very thin, for example of the order of magnitude of one tenth of a millimetre.

FIG. 3 shows the use of a binding element 1 according to the invention to form a folder, whereby in this case use is made of a slat 13 over which the binding element 1 is affixed in the reverse situation with the arms 4 downwards.

This slat 13 is produced from thermally insulating material for example and comprises one or more resistors 14 or other heating elements that are at a distance A from the top edge 15 at the level of the lips 9, below the free edge 5 of the arms 4.

These heating elements 14 are intended to be able to heat the assembly adhesive 8 at the location of the lips 9 to a temperature that is at least equal to the melting temperature of the assembly adhesive 8.

The slat 13 is provided with a thickening at the bottom that somewhat pushes the lips 9 outwards away from one another.

In order to form the binding folder 16 a sheet of cardboard 17 of approximately 200 to 250 grams/m² is folded around the outer surface 18 of the binding element to form the cover 19 of the folder 16, as shown in FIG. 3, whereby the cardboard is brought into contact with the lips 9 where the assembly adhesive 8 is made to melt briefly.

In order to bring about a better contact, optionally a pressing element, not shown in the drawings, can be provided on either side of the slat 13 at the level of the lips 9 in order to be able to press the lips 9 against the slat 13.

After the assembly adhesive 8 on the lips 9 has cooled, a binding folder 16 is obtained with a cover 19 in which the binding element 1 is bonded, as can be seen in FIG. 4.

It is clear that such a binding folder 16 can also be produced in other ways, whereby for example a slat 13 is not necessary to locally heat the lips of the binding element.

Additionally the sheet of cardboard 17 of the cover 19 can be bonded to the metal spine 2 over the entire or practically entire outer surface 18 of the metal spine 2, for example with contact adhesive or similar.

To bind a bundle 20 of leaves 21 in the binding folder 16, the bundle 20 to be bound is inserted with its bottom edge 22 in the binding element 1, as shown by the arrows B in FIG. 4.

It is clear that the insertion of the bundle 20 is not impeded by the free edges 5 of the arms 4 as they are covered by the lips 9 of the cover strip 7 and these lips 9 form a guide as it were for the insertion of the leaves 21.

In order to bind the bundle 20, the bundle 20 is introduced in the binding folder until the bottom edge of the bundle 20 rests on the binding adhesive 12.

The binding folder 16 is placed in a known way with the spine on a heating element 23 that can heat the binding adhesive 12 to a temperature that is at least equal to the melting temperature of the binding adhesive 12, but which is lower than the melting temperature of the assembly adhesive 8.

In this way the binding adhesive 12 is made to melt without the assembly adhesive 8 being able to melt, and the edge 22 of the bundle 20 to be bound penetrates into the binding adhesive 12.

Simultaneously, if necessary the top free edge 5 of the arms 4 are pushed towards one another up to against the outermost leaves 21 of the bundle 20 as shown by the arrows C, and this is to close the opening between the bundle 20 and the edges 5 of the arms 4.

After the binding adhesive 12 has cooled the leaves 21 are firmly bound in the binding folder 16.

FIG. 6 describes an alternative embodiment of a binding element 1 according to the invention that differs from the binding element 1 of FIGS. 1 and 2 in the fact that in this case the cover strip does not run over the base 3 of the metal spine, but that there are two cover strips 7 that are fastened by means of their assembly adhesive 8 to the inside 6 of the arms 4.

In this case the binding adhesive is applied directly to the base of the metal spine 2.

The formation of a binding element according to the invention, as shown in FIGS. 1 and 2, can be explained on the basis of FIG. 7.

First a flat cover strip 7 of suitable dimensions is provided with a layer of assembly adhesive 8 on one side in the form of a hotmelt adhesive, and a flat metal spine 2 is then placed against it and a small layer of binding adhesive 12 is provided in the middle of the flat cover strip 7.

The flat element formed is then transformed, for example by means of a stamp 24 and a die 25 or similar, into a U-shaped binding element 1 as shown in FIGS. 1 and 2, by pressing the flat element with the stamp 24 in the die 25 in the direction of the arrow D.

FIG. 8 outlines a method, in a similar way as FIG. 7, for forming a binding element such as that of FIG. 6.

The present invention is by no means limited to the embodiments described as an example and shown in the drawings, but a binding element according to the invention for binding leaves in a binding folder with a cover and a method applied therewith can be realised in all kinds of variations without departing from the scope of the invention.

1. Binding element for binding leaves (21) in a binding folder (16) with a cover (19), whereby this binding element (1) essentially comprises a metal spine (2) and a binding adhesive (12) in the form of a hotmelt adhesive, whereby the metal spine (2) is essentially formed as a U-shaped profile with a base (3) and upright arms (4), wherein the inside (6) of the metal spine (2), at least at the location of the arms (4), is provided with at least one cover strip (7) of paper, plastic, metal foil or similar, and on the side oriented towards the inside (6) of the meal spine (2) is provided with an assembly adhesive (8) in the form of a hotmelt adhesive with a melting temperature that is higher than that of the binding adhesive (12), and with which the cover strip (7) is bonded to a section on the inside (6) of the metal spine (2) to form a free lip (9) on each arm (4), whereby the lips (9) protrude from the metal spine (2) past the arms (4) towards the outside, and are provided with assembly adhesive (8) on their outside (10).

2. Binding element according to claim 1, wherein the lips (9) are formed by a cover strip (7) that runs over the base (3) of the metal spine (2) from one arm (4) to the other arm (4).

3. Binding element according to claim 1, wherein there is only one cover strip (7) that extends over the entire or practically entire inside (6) of the metal spine (2).

4. Binding element according to claim 3, wherein the binding adhesive (12) is applied at least at the location of the base (3) of the metal spine (2).

5. Binding element according to claim 4, wherein the binding adhesive (12) is applied to the inside (11) of the cover strip (7).

6. Binding element according to claim 1, wherein the metal spine (2) is constructed such that the free edges (5) of the arms (4) can be folded towards one another.

7. Binding element according to claim 1, wherein the binding adhesive (12) has a melting temperature that is between 80° C. and 90° C.

8. Binding element according to claim 1, wherein the assembly adhesive (8) has a melting temperature that is between 120° C. and 140° C.

9. Binding folder with cover, wherein the binding folder (16) comprises a cover (19) of cardboard or similar and a binding element (1) according to claim 1 to form the spine of the binding folder (16), whereby the cover (19) runs over the outer surface (18) of the metal spine (2) of the binding element (1) and is fastened to the binding element (1) at least by means of the assembly adhesive (8) on the free lips (9) of the binding element (1).

10. Binding folder according to claim 9, wherein the binding folder (16) is bonded to the metal spine (2) over the entire or practically entire outer surface (18) of the metal spine (2).

11. Binding folder according to claim 9, wherein the cover (19) is formed of cardboard of approximately 200 to 250 grams/m².

12. Method for forming a binding folder according to claim 1, which starts with a binding element (1) and a sheet of cardboard (17) or similar to form the cover (19), whereby the sheet of cardboard (17) is folded over and against the outer surface (18) of the binding element (1) up to against the lips (9) of the binding element (1) with assembly adhesive (8), after which the assembly adhesive (8) on these lips (9) is heated to locally melt the assembly adhesive (8) and then to allow the assembly adhesive (8) to solidify to bring about the bond between the binding element (1) and the cover (19).

13. Method according to claim 12, wherein the metal spine (2) is affixed in the reverse position, i.e. with the arms (4) downwards, over a slat (13) that is heated at the location of the lips (9) to a temperature that is greater than or equal to the melting temperature of the assembly adhesive (8), after which the sheet of cardboard (17) that is to form the cover (19) is placed on the binding element (1) and folded downwards around the outer surface (18) of the metal spine (2) of the binding element (1) up to against the molten assembly adhesive (8).

14. Method according to claim 13, wherein the slat (13) is made of thermally insulating material and in the slat (13) heating (14) is only provided at the location of the contact zone with the lips (9) of the binding element (1).

15. Method according to claim 14, wherein a pressing element is provided on either side of the slat (13) at the level of the lips (9) so as to be able to push the lips (9) against the slat (13).

16. Binding element according to claim 2, wherein there is only one cover strip (7) that extends over the entire or practically entire inside (6) of the metal spine (2).

17. Binding element according to claim 1, wherein the binding adhesive (12) is applied at least at the location of the base (3) of the metal spine (2).

18. Binding folder according to claim 10, wherein the cover (19) is formed of cardboard of approximately 200 to 250 grams/m².
